(19) United States
(12) Patent Application Publication
(10) Pub. No.: US 2019/0145311 A1
(43) Pub. Date: May 16, 2019

(54) SYSTEMS AND METHODS FOR A DUAL DRIVE GENERATOR

(71) Applicant: General Electric Company, Schenectady, NY (US)

(72) Inventors: Randall John Kleen, Houston, TX (US); Scott Vernon Neumueller, Houston, TX (US)

(21) Appl. No.: 15/815,409

(22) Filed: Nov. 16, 2017

(51) Int. Cl. F02B 63/04

(52) U.S. Cl. CPC F02B 63/042

(57) ABSTRACT

A gas turbine may include a rotational shaft that couples to a first generator and a second generator. The gas turbine may include a controller that receives one or more load parameters that corresponds to a first set of electrical properties associated with one or more loads coupled to the first generator, the second generator, or both, that receives one or more sensed parameters from one or more sensors that measure a second set of electrical properties associated with the one or more loads, that determines one or more differences between the one or more load parameters and the one or more sensed parameters, and that controls one or more operations of the first generator, the second generator, or both based on the differences.

### BACKGROUND

The subject matter disclosed herein relates to turbomachinery, and more particularly, to gas turbines used in power generation.

In power generation systems, turbines, such as gas turbines or steam turbines, may convert fuel and air (e.g., an oxidant) into rotational energy. For example, a gas turbine may compress the air, via a compressor, and mix the compressed air with the fuel to form an air-fuel mixture. A combustor of the gas turbine may then combust the air-fuel mixture and use energy from the combustion process to rotate one or more turbine blades and a rotational shaft, thereby generating rotational energy. The rotational energy of a rotational shaft may then be converted into electricity, via a generator, to be provided to an electrical grid, a vehicle, or another load.

Various sub-systems of the gas turbine may be controlled to improve efficiency or power output of the gas turbine. For example, the gas turbine may include a controller (e.g., a proportional-integral-derivative (PID) controller) that controls temperatures or pressures, among others. However, efficiency improvements provided from the controller may not account for all system inefficiencies.

### BRIEF DESCRIPTION

Certain embodiments commensurate in scope with the originally claimed disclosure are summarized below. These embodiments are not intended to limit the scope of the claimed disclosure, but rather these embodiments are intended only to provide a brief summary of possible forms of the disclosure. Indeed, embodiments may encompass a variety of forms that may be similar to or different from the embodiments set forth below.

In one embodiment, a gas turbine may include a rotational shaft that couples to a first generator and a second generator. The gas turbine may also include a controller that receives one or more load parameters that correspond to a first set of electrical properties associated with one or more loads coupled to the first generator, the second generator, or both, that receives one or more sensed parameters from one or more sensors that measure a second set of electrical properties associated with the one or more loads, that determines one or more differences between the one or more load parameters and the one or more sensed parameters, and that controls one or more operations of the first generator, the second generator, or both based on the differences.

In another embodiment, a gas turbine system may include a rotational shaft with a first side and a second side. The gas turbine system may also include a first generator that couples to the first side of the rotational shaft. The gas turbine system may also include a second generator that couples to the second side of the rotational shaft. The gas turbine system may also include a controller that controls one or more operations associated with the first generator, the second generator, or both.

In yet another embodiment, a method may involve receiving, via a processor, one or more load parameters that corresponds to a first set of electrical properties associated with one or more loads coupled to a first generator, a second generator, or both, wherein the first generator and the second generator may couple to a shaft of a turbine. The method may also involve receiving, via the processor, one or more sensed parameters from one or more sensors configured to measure a second set of electrical properties associated with the one or more loads that couple to the first generator, the second generator, or both. The method may also involve determining, via the processor, one or more differences between the one or more load parameters and the one or more sensed parameters. The method may also involve controlling, via the processor, one or more operations of the first generator, the second generator, the turbine, or any combination thereof, based on the differences.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a block diagram of a turbine-generator system, in accordance with an embodiment;

FIG. 2 illustrates a block diagram of a dual drive generator system that controls one or more operating parameters of multiple generators, in accordance with an embodiment;

FIG. 3 illustrates a first schematic diagram depicting the power flow via the dual drive generator system of FIG. 2, in accordance with an embodiment;

FIG. 4 illustrates a second schematic diagram depicting the power flow via the dual drive generator system of FIG. 2, in accordance with an embodiment;

FIG. 5 illustrates a third schematic diagram depicting the power flow via the dual drive generator system of FIG. 2, in accordance with an embodiment; and

FIG. 6 illustrates a flow diagram of a method for providing adjustments to a dual drive generator system, in accordance with an embodiment.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. One or more specific embodiments of the present embodiments described herein will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Embodiments of the present disclosure are related to the manner in which generators may be coupled to a rotational shaft of turbomachinery, such as gas turbines, steam turbines, or compressors. Generally, a gas turbine may include one or more compressors, a combustor, and one or more turbine blades. The gas turbine may receive an oxidant, such as air, in the one or more compressors that compress the air to a higher pressure. The air is mixed with fuel to form an air-fuel mixture that is combusted by the combustor. Energy from the combustion process is used to rotate turbine blades of the one or more turbines. The rotational energy of the turbine blades may rotate a shaft coupled to the turbine blades to drive one or more loads, such as a vehicle or an electrical generator. The electrical generator may be coupled to an electrical grid to provide power that is used for residential, industrial, or any other suitable purpose.

Keeping the foregoing in mind, embodiments of the present disclosure describe systems and methods that account for two separate loads coupled to a single rotational shaft. In some embodiments, connecting two generators to the rotational shaft of a gas turbine to create a dual drive generator may be useful to increase the flexibility in which the turbine can be employed. By way of example, one generator may be coupled to a gas turbine at an air intake side of the rotational shaft and another generator may be coupled to the gas turbine at an exhaust side of the rotational shaft. In this way, the two generators may be coupled to opposite ends of the same rotational shaft of the gas turbine. The two generators sharing the same rotational shaft may eliminate one of the two rotational shafts and/or two gas turbines to drive the two generators.

By using both sides of the rotational shaft, as opposed to using one side of the rotational shaft, the dual drive generator may efficiently use rotational energy of the rotational shaft to provide energy to two generators. In addition, the two generators may share the energy provided via the rotational shaft without reducing operational flexibility of the two generator systems. That is, the dual drive generator may use controllers to change the operation of each generator independently while providing energy via the same rotational shaft. In some embodiments, the dual drive generator may have two exciters and two starters for independent control of each of the generators attached to the rotational shaft. For example, the first generator may operate to provide a first amount of power and the second generator may operate to provide a second amount of power. The two generators may provide the same amount or different amounts of power. The power provided by each of the two generators may include real or reactive power.

In addition, the generators coupled to the dual drive generator may be designed to accommodate various types of arrangements. For instance, the first generator may provide power to a first load, the second generator may provide power to a second load, and/or the first generator and the second generator may provide power to the same load. As such, the dual drive generator may provide an improved solution to power generation at least in part because it may reduce the physical requirements of having two turbines to drive two generators. By eliminating one of the rotational shafts and/or the second gas turbine, the physical weight and size of the system may decrease, thereby reducing the costs and space involved in power generation applications.

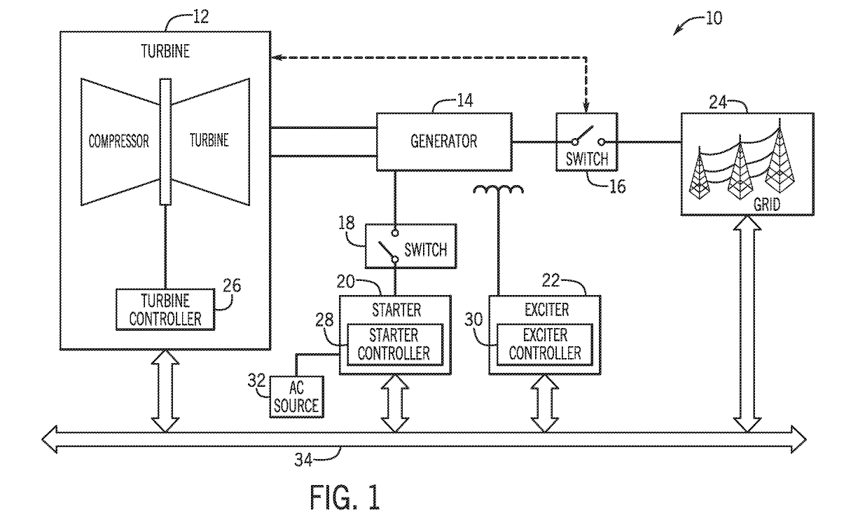

By way of introduction, FIG. 1 illustrates a block diagram of a turbine-generator system 10 that may be employed in the embodiments described herein. As shown in FIG. 1, the turbine-generator system 10 may include a turbine system 12, a generator 14, a switch 16, a switch 18, a starter component 20, an exciter component 22, and an electrical grid 24. The turbine system 12 may include any one or more turbines and may be configured as a simple cycle or a combined cycle. By way of example, the turbine system 12 may include a gas turbine, a wind turbine, a steam turbine, a water turbine, or any combination thereof. In the turbine-generator system 10, the mechanical work output by the turbine system 12 may rotate a shaft of the generator 14. In general, the generator 14 may then convert the rotation of the shaft into electrical energy that may be output to the electrical grid 24.

The starter component 20 may be a variable frequency drive, a load commutated inverter (LCI), or a similar type of electrical device that may output an alternating current (AC) voltage that may be provided to a stator of the generator 14. In one embodiment, the starter component 20 may receive an AC voltage from an AC voltage source 32 and may convert the AC voltage into the controlled AC voltage, which may be provided to the stator of the generator via the switch 18.

The exciter component 22 may include an electrical circuit that provides direct current (DC) current and a DC voltage to field windings of a rotor of the generator 14, thereby inducing a magnetic field within the generator 14. The magnetic field may then cause the rotor to spin inside the generator and rotate the shaft of the generator 14. In addition to creating the magnetic field within the generator 14, the exciter component 22 may be used to control the frequency, amplitude, and phase properties of the voltage output by the generator 14. As such, the exciter component 22 may be used to synchronize the voltage output by the generator 14 with the voltage of the electrical grid 24 after the generator's shaft rotates at its rated speed.

The turbine system 12, the starter component 20, and the exciter component 22 may include controllers, such as a turbine controller 26, a starter controller 28, and an exciter controller 30, which may control the turbine system 12, the starter component 20, and the exciter component 22, respectively. The turbine controller 26, the starter controller 28, and the exciter controller 30 may each include a communication component, a processor, a memory, a storage, input/output (I/O) ports, and the like. The communication component may be a wireless or wired communication component that may facilitate communication between each component in the turbine-generator system 10, various sensors disposed about the turbine-generator system 10, and the like. The processor may be any type of computer processor or microprocessor capable of executing computer-executable code. The memory and the storage may be any suitable articles of manufacture that may serve as media to store processor-executable code, data, or the like. These articles of manufacture may represent non-transitory computer-readable media (i.e., any suitable form of memory or storage) that may store the processor-executable code used by the processor to, among other things, perform operations that may be used to control the turbine system 12, the starter component 20, and the exciter component 22. The non-transitory computer-readable media may indicate that the media is tangible and not a signal. The turbine controller 26, the starter controller 28, and the exciter controller 30 may communicate with each other via a communication network 34. The communication network 34 may include an Ethernet-based network, such as the Unit Data Highway (UDH) provided by General Electric.

Generally, the turbine system 12 may rotate a shaft in the generator 14, such that the generator 14 outputs a voltage. The voltage output of the generator 14 may then be synchronized with the voltage of the electrical grid 24 and provided to the electrical grid 24 via the switch 16. The turbine controller 26 may respond to changes in the electrical properties of the electrical grid 24 to synchronize the voltage output of the generator 14.

In certain embodiments, the turbine controller 26, the starter controller 28, and/or the exciter controller 30 may use sensors to measure and monitor electrical properties of the electrical grid 24. As such, the sensors may facilitate the controllers in monitoring the electrical grid 24 for transient events such as a rise or fall in grid frequency, a rise or fall in active power or reactive power of the generator 14, and the like. The transient event may include changes to electrical properties such as voltage, current, power, power factor, and the like.

The turbine controller 26 may adjust one or more operations of the turbine system 12 to provide stability between the electrical properties of the electrical grid 24 in view of sensed parameters from the sensors. As such, when the transient event occurs on the electrical grid 24, the turbine controller 26 may adjust the rotation of the turbine shaft or compensate for a discrepancy between the sensed parameters of the electrical grid 24 and the desired operation, or load parameters, of the electrical grid 24.

Similarly, the turbine controller 26, the starter controller 28, and/or the exciter controller 30 may adjust one or more operations of the turbine-generator system 10 to the electrical properties of the electrical grid in view of the sensed parameters from the sensors. A difference between the sensed parameters and load parameters may help determine if an adjustment is performed. The turbine controller 26, the starter controller 28, and/or the exciter controller 30 may implement an adjustment if the difference is outside a threshold. In this way, the turbine controller 26, the starter controller 28, and/or the exciter controller 30 may adjust the power provided to the electrical grid 24 to adjust the electrical properties of the electrical grid 24 to the desired operation.

In some embodiments, the turbine system 12 may drive two generators using one rotational shaft in a dual drive generator system. In the dual drive generator system the turbine controller 26, the starter controller 28, and/or the exciter controller 30 may adjust either of the two generators, or the turbine system 12 to adjust the electrical properties of the electrical grid 24 to the a desired operation. It is noted that by driving power generation from two generators from one rotational shaft, the dual drive generator system may improve power generation methods by possibly reducing costs, reducing physical requirements, increasing efficiency, all while maintaining the operational flexibility of a two generator power generation system.

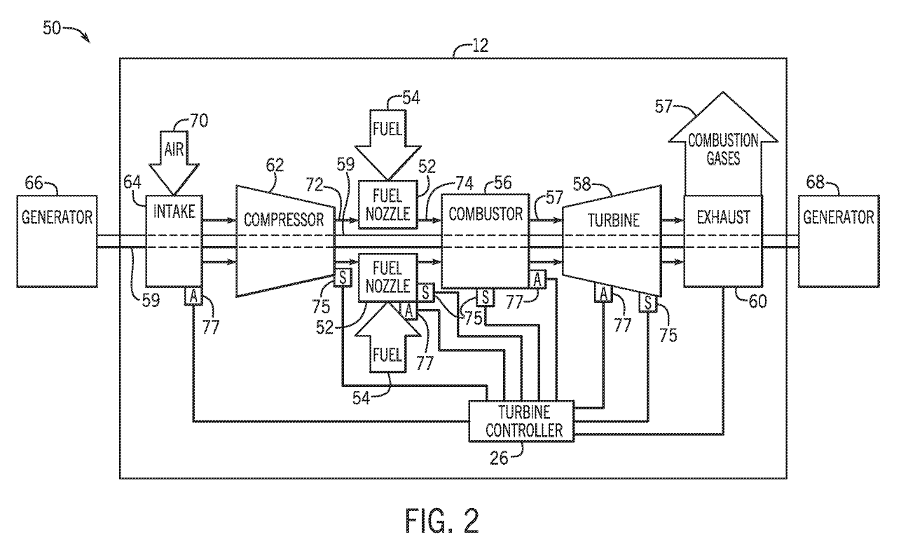

FIG. 2 illustrates a block diagram of a dual drive generator system 50, as described above. As shown in FIG. 2, the turbine system 12 may include fuel nozzles 52, a fuel supply 54, and a combustor 56. As depicted, the fuel supply 54 routes a liquid fuel or gas fuel, such as natural gas or syngas, to the dual drive generator system 50 through the fuel nozzle 52 and into the combustor 56. The combustor 56 ignites and combusts the fuel-air mixture, and then passes hot pressurized combustion gases 57 (e.g., exhaust) into a turbine 58. Turbine blades may couple to a shaft 59 (e.g., rotational shaft), which couples to several other components throughout the dual drive generator system 50, as illustrated. As the combustion gases 57 pass through the turbine blades in the turbine 58, the turbine 58 rotates, which also causes the shaft 59 to rotate. Eventually, the combustion gas 57 may exit the dual drive generator system 50 via an exhaust outlet 60.

In some embodiments, the compressor 62 may include compressor blades. The compressor blades may couple to the shaft 59, and may turn as the turbine 58 rotates the shaft 59. The shaft 59 may couple to a generator 66, which may provide power via rotation of the shaft 59. In some embodiments, the shaft 59 may also couple to a generator 68, which may also provide power via rotation of the shaft 59. By way of example, the generators 66 and 68 are any suitable device that may provide power via the rotational output of the turbine system 12, such as an external mechanical generator, an electrical generator, a propeller of an airplane, and the like.

By way of operation, the turbine system 12 may receive air 70 (e.g., cold air) via the air intake 64. The air 70 taken in by the turbine system 12 compresses into pressurized air 72 by rotating the compressor blades within the compressor 62. Pressurized air 72 may mix with fuel 74 provided via the fuel nozzle 52 to produce a suitable mixture ratio for combustion (e.g., a combustion that causes the fuel to more completely burn, so as not to waste fuel or cause excess emissions).

The turbine system 12 also includes sensors 75 to acquire measurements associated with operation of the turbine system 12. The sensors 75 may couple to the fuel nozzle 52, the combustor 56, the turbine 58, the compressor 62, and the like. In certain embodiments, the exhaust outlet 60 may couple to a heat recovery steam generator (HRSG) to recover heat from the exhaust to provide steam for use in various applications such as a steam turbine, which in turn may couple to an exhaust stack. The exhaust stack may redirect the HRSG's exhaust gases into the atmosphere. Accordingly, the sensors 75 may also couple to the various power plant components, such as the HRSG and the exhaust stack.

The sensors 75 may obtain various measurements regarding fluid, temperature, pressure, electrical properties, and the like. That is, certain sensors 75 may be used to measure properties of a gas, a gas-liquid mixture, or a liquid, and certain sensors 75 may be used to measure electrical properties like voltage, current, power, power factor, and the like. For example, the sensor 75 coupled to the compressor 62 may be an acoustic sensor to measure compressor outlet pressure. As such, the sensors 75 may acquire measurements associated with operation of the turbine system 12. When operated in this way, the sensors 75 measurements may indicate one or more operations of the turbine system 12. The sensors 75 may transmit signals indicative of the measurements to portions of the dual drive generator system 50 that electrically couple to the sensors 75. The transmitted signals indicative of measurements are sensed parameters.

In some embodiments, a turbine controller 26 may electrically couple to one or more of the sensors 75 to receive signals indicative of one or more operations of the turbine system 12. For example, the turbine controller 26 may receive a signal indicative of a measurement of the power provided by the generators 66 and 68. The turbine controller 26 may determine a difference between the sensed parameter indicative of the power measurement and the load parameter associated with the power measurement. If the difference is outside a threshold, the turbine controller may determine an adjustment to make to one or more operations of the turbine system 12. The turbine controller 26 may make the adjustment to decrease the difference between the sensed parameter and the load parameter, thereby bringing the difference within the threshold. The turbine controller 26 may electrically couple to one or more actuators 77 to perform the adjustment. The adjustment may include sending commands to implement the adjustment via control signals to adjust one or more operations of the turbine system 12. As such, the turbine controller 26 may send a signal to the actuator 77 coupled to the fuel nozzle 52 to control flow of the fuel entering the fuel nozzle 52, thereby controlling one or more operations of the turbine system 12 and adjusting the power provided by the generators 66 and 68.

As described, the turbine controller 26 may additionally control one or more operations of the turbine system 12 based the on the sensed parameters of the load. Similar to the previous example, the turbine controller 26 may receive sensed parameters indicative of the load operation in addition to sensed parameters of the operation of the turbine system 12. Generally, the turbine controller 26 may determine a difference between the sensed parameters of the load and the load parameters for the load. If a difference is outside a threshold, the turbine controller 26 may determine an adjustment to make to the turbine system 12 to decrease the difference to be within the threshold. The turbine controller 26 may proceed to control of the turbine system 12 through transmitting signals indicative of the adjustment to the actuators 77. It is noted that the load may be the load of the turbine system 12 (e.g., the generator 66, the generator 68) or the load may be the loads of the dual drive generator system 50 (e.g., the loads electrically coupled to the generator 66 and/or the generator 68). Thus, based on the sensed parameters, the turbine controller 26 may adjust one or more operations of the turbine system 12 to account for the difference between the sensed parameter and load parameter.

In certain embodiments, the controllers (e.g., turbine controller 26, starter controller 28, exciter controller 30) may act to decrease differences between sensed parameters and load parameters until the difference is within a threshold. The controllers may adjust the respective operations of the generators 66 or 68 in response to the difference between the sensed parameter and the load parameter. The controllers may adjust the operation of each of the generators 66 or 68, respectively. In this way, the controllers may independently adjust the electrical properties of the respective outputs of each generator 66 and 68. Through this, the controller may operate the generator 66 to provide a first amount of power and may operate the generator 68 to provide a second amount of power, independent of the power provided by the generator 66. In some embodiments, the first amount of power may equal the second amount of power.

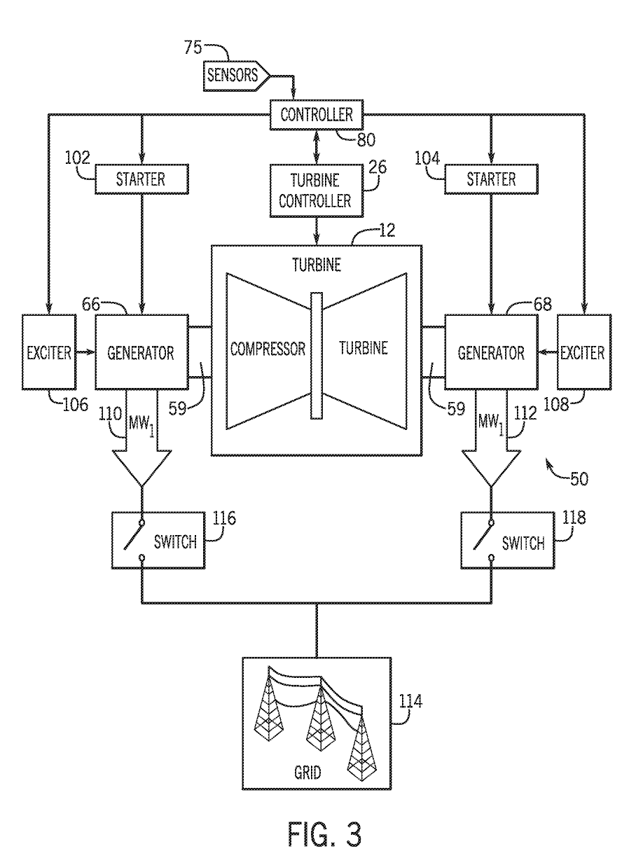

FIG. 3 illustrates a schematic diagram of the power flow of the dual drive generator system 50, as described above. As shown in FIG. 3, the dual drive generator system 50 may include a starter 102, a starter 104, an exciter 106, an exciter 108, and a controller 80. The generators 66 electrically couples to the starter 102 and to the exciter 106. The generator 68 electrically couples to the starter 104 and the exciter 108. The starters 102 and 104 may function similar to the starter component 20, respectively. The exciters 106 and 108 may function similar to the exciter component 22, respectively. As described prior, the starters 102 and 104 and the exciters 106 and 108 may operate to change one or more operations of the generators 66 and/or 68 via signals transmitted to the starter controller 28, internal to starters 102 and 104, or to the exciter controller 30, internal to exciters 106 and 108, respectively.

To elaborate, the controller 80 may signal an adjustment to the starter controller 28, the exciter controller 30, and/or turbine controller 26 to change operation of the starter 102 and/or 104, the exciter 106 and/or 108, and/or the turbine system 12. Through a combination of the adjustments to the starters 102 or 104, the exciters 106 or 108, and/or the turbine system 12, the controller 80 may adjust the operation of the generator 66 and/or 68. The outputs 110 and 112 may vary based on the operation of the generators 66 and 68. In this way, the starters 102 and 104, the exciters 106 and 108, and the turbine system 12 may facilitate in the variance of the outputs 110 and 112. As depicted, the controller 80 may control the operations of the generators 66 and 68 to output the same amount of power (e.g., MW₁).

An electrical grid 114 may electrically couple to the outputs 110 and 112. The electrical grid 114 may function similar to the electrical grid 24. The switch 116, similar to switch 16, may act to isolate the output 110 and the generator 66 from the electrical grid 114. The switch 118, similar to switch 16, may act to isolate the output 112 and the generator 68 from the electrical grid 114. As illustrated, the outputs 110 and 112 may both be an equivalent real power amount provided to the same electrical grid 114. When operated in this manner, the real power provided to the electrical grid 114 may contribute to the overall power provided to the electrical grid 114. In some embodiments, the generator 66 may provide reactive power and the generator 68 may provide real power to the electrical grid 114.

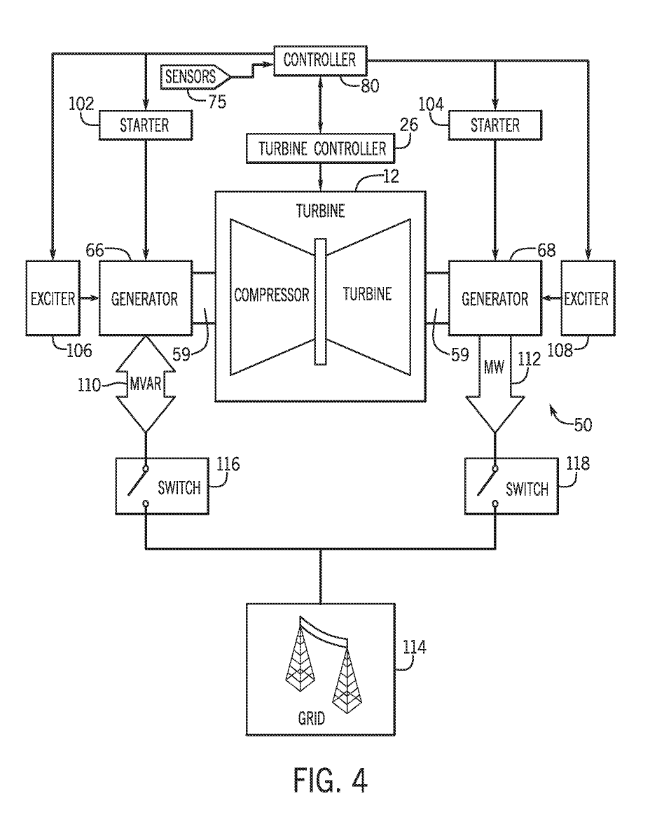

FIG. 4 illustrates a second schematic diagram depicting the power flow via the dual drive generator system 50, as described above. As depicted, the generator 66 may provide reactive power to the electrical grid 114 via output 110. Additionally, the generator 68 may provide real power to the electrical grid 114 via output 112. In some embodiments, the generators 66 and/or 68 may individually operate to provide reactive power or real power. For example, the generator 66 may operate to provide real power to the electrical grid 114 and the generator 68 may operate to provide reactive power to the electrical grid 114. The electrical properties of the electrical grid 114 may determine whether to provide real power or to provide reactive power from the generators 66 and 68. For example, the electrical grid 114 may indicate that reactive power from the generators 66 and/or 68 may assist the electrical grid 114 to maintain the stability of the electrical grid 114. In this case, the controller 80 may provide a command to the starter 102 and/or the exciter 106 to cause the generator 66 to output the reactive power.

In some embodiments, the sensors 75 disposed throughout the electrical grid 114 may measure the electrical properties of the electrical grid 114. The sensors 75 may transmit sensed parameters to the controller 80. The controller 80 may determine an adjustment to one or more operations of the dual drive generator system 50 based on the difference between the sensed parameters and the load parameters. The controller 80 may transmit the adjustment to the turbine controller 26, the exciter 106 or 108, and/or the starter 102 or 104. The controller 80, through transmitting the adjustment, thereby controls one or more operations of the dual drive generator system 50 based on the sensed parameter and the load parameter.

For example, if the electrical grid 114 is operating at a voltage, where the difference between the sensed voltage parameter (e.g., frequency) and the load voltage parameter is outside a threshold, the controller 80 may signal an adjustment to the turbine controller 26 to operate the turbine system 12 to slow rotation of the shaft 59. By slowing rotation of the shaft 59, the controller 80 may reduce the frequency in which both of the generators 66 and 68 operates because the shaft 59 drives both of the generators 66 and 68. Additionally or alternatively, the controller 80 may signal an adjustment to the exciter controller 30 to decrease a voltage output provided to generator 66 or 68. By decreasing a voltage provided to one of the generators 66 or 68, the controller 80 adjusts the power provided by one of the generators 66 or 68. The adjustments made by the controller 80 may account for the difference between the sensed parameters and the load parameters through adjusting both generators 66 and 68 or through adjusting one of the generators 66 or 68.

As an additional example, a load parameter may include a balanced electrical grid 114 (e.g., operating at unity power factor) as the desired operation for the electrical grid 114. As such, the controller 80 may adjust the operation of the turbine system 12, the generators 66, and/or the generator 68, such that the electrical grid 114 maintains the desired operation defined by load parameter. The sensor 75 may transmit a signal indicative of a sensed parameter (e.g., voltage, frequency) of the electrical grid 114 to the controller 80. The controller 80 may use the difference between the sensed parameter and the load parameter to determine an adjustment to the amount of real or reactive power that generators 66 or 68 provide to the electrical grid 114 to maintain the desired operation. As illustrated with the example, to account for the difference, the controller 80 may operate the generator 66 to provide reactive power, while the controller 80 may operate the generator 68 to provide real power. As such, the controller 80 may adjust control signals provided to the starters 102 and 104 and the exciters 106 and 108 to cause the generators 66 and 68 to output real and/or reactive power to maintain the desired operation of the electrical grid 114.

As shown through the examples above, the generator 66 may provide a first amount of reactive power and the generator 68 may provide a second amount of real power to the electrical grid 114. In addition, it should be noted that, in some embodiments, the generator 66 may provide a first amount of real power to a first load and the generator 68 may provide a second amount of real power to a second load, where the first load and the second load use different amounts of power to operate.

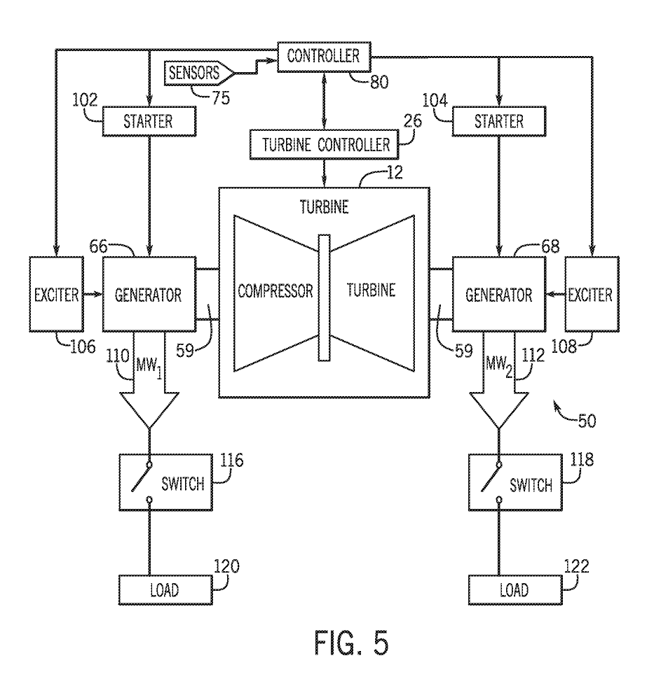

With the foregoing in mind, FIG. 5 illustrates a third schematic diagram depicting the power flow via the dual drive generator system 50, as described above. As illustrated, the generator 66 may provide a first amount of real power (e.g., MW₁) to a load 120 and the generator 68 may provide a second amount of real power (e.g., MW₂) to a load 122. The loads 120 and 122 may be a circuit or a portion of the circuit that consumes power, such as, appliances, lights, electrical circuits of buildings, equipment, and the like. In some embodiments, the loads 120 and 122 may be various combinations of electrical grids and/or power islands.

As discussed earlier, the starters 102 and 104 and the exciters 106 and 108 may determine the operation of the generators 66 and 68, respectively. The controller 80 may independently operate the starter 102, the exciter 106, the starter 104, and exciter 108. Based on input received from the controller 80, the starter 102 and/or the exciter 106 may operate the generator 66 to provide the first amount of power via output 110 to the load 120. Similarly, the starter 104 and/or the exciter 108 may operate the generator 68 to provide the second amount of power via output 112 to the load 122. The output 110 may provide a different amount of power than the output 112. Although the present disclosure of FIG. 5 is described as providing real power with the generators 66 and 68, it should be noted that the controller 80 may operate the generators 66 and 68 to provide different amounts of real and/or reactive power in a variety of arrangements in addition to the combinations described.

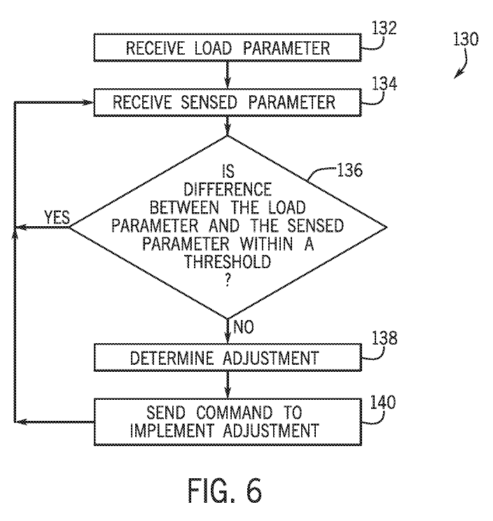

With the foregoing in mind, FIG. 6 illustrates a flowchart of a method 130 for monitoring and providing adjustments to the dual drive generator system 50. Although the method 130 is described below as being performed by the controller 80, it should be noted that the method 130 may be performed by any suitable processor to adjust any suitable dual drive generator system. Moreover, although the following description of the method 130 is described in a particular order, it should be noted that the method 130 may be performed in any suitable order.

Referring to FIG. 6, at block 132, the controller 80 may receive a load parameter. The load parameter may define the desired operation of a load (e.g., load 120, load 122, electrical grid 114, electrical grid 24) coupled to the generators 66 or 68. The load parameter may correspond to a variety of electrical properties of the load. In this way, the load parameter may indicate a desired operation characteristic of the load. The load parameter may vary with application and load requirements (e.g., physical limits, technical specifications). The controller 80 may use a sensed parameter in determining a difference between the operation of the load and the desired operation of the load.

At block 134, the controller 80 may receive the sensed parameter from the sensor 75. The sensed parameter may include a signal indicative of a measurement made by the sensor 75 regarding the operation the load. As described earlier, a communication component of the controller 80 may transmit the sensed parameter from the sensor 75, which may be disposed at various locations with respect to the load. In some instances, the load parameter and the sensed parameter may belong to the same category of measurement (e.g., voltage measurement, current measurement, phase measurement). In this way, the controller 80 has a target amount (e.g., load parameter) and an actual amount (e.g., sensed parameter) for the operation of the load. However, when the load parameter and the sensed parameter belong to different categories of measurement, the controller 80 may transform the sensed parameter into a measurement unit that may be compared to the provided load parameter.

At block 136, the controller 80 may determine if a difference between the load parameter and the sensed parameter is within a threshold. The threshold may be a range of values that are determined based on the load. In this way, the threshold may change based on how the load is being used and on what type of load is being used. The threshold may correspond to a desired range of operation of the load. When the load operates such that the difference between the sensed parameter and the load parameter is outside the threshold, the controller 80 may use the difference to determine an adjustment to correct the undesired operation of the load.

As discussed above, if the difference is outside the threshold, the controller 80 may return to block 132 and continue to monitor the load. The controller 80 may continue following the method 130 until the difference between the load parameter and the sensed parameter is outside the threshold range. In this way, the controller 80 may continue to monitor the operation of the load.

If the difference is not outside the threshold, the controller 80 may continue to block 138 to determine an adjustment. The goal of the adjustment is to correct the undesired operation of the load. Thus, the controller 80 may adjust operation of the turbine system 12, the generator 66, and/or the generator 68 to correct the undesired operation of the load. In some embodiments, the controller 80 may use a combination of adjustments to adjust the operation of the turbine system 12, the generator 66, and/or the generator 68 to correct the undesired operations of the load.

For example, the load parameter may define the desired operation of the load as operating at unity power factor. The controller 80 may use the difference between the sensed parameter and the load parameter to determine an amount of real or reactive power that generators 66 or 68 should output to the load to maintain the desired operation of unity power factor. The controller 80 may determine to adjust the generator 66 to provide reactive power to the load or may determine to adjust the generator 68 to provide real power to the load. The controller 80 may further determine the adjustment by determining adjustments to the control signals provided to the starters 102 or 104 and/or the exciters 106 or 108. The controller 80 may determine the adjustments to perform such that the generators 66 and 68 output real and/or reactive power to achieve the desired operation of the load after the adjustment. The controller 80 implements the adjustment via commands sent to the turbine controller 26, the exciter controller 30, and/or the starter controller 28.

At block 140, the controller 80 may send a command to other control components to implement the adjustment. That is, the controller 80 may implement the adjustment through sending commands to the turbine controller 26, the exciter controller 30, and/or the starter controller 28. The controllers may receive the commands and execute the commands, thereby performing adjustments to the operation of the turbine system 12, the generator 66, and/or the generator 68. Through the execution of the commands indicating the adjustment, the load may operate as desired.

Technical effects of the present disclosure include power generation from a dual drive generator system. The dual drive generator system, using one rotational shaft to drive two generators, may improve the efficiency of power generation and may reduce physical size while maintaining the operational flexibility provided from using two generators for power generation. As described, one generator may couple at the air intake side of a turbine system and one generator may couple at the exhaust side of the turbine system, possible through the coupling of the two generators to opposite ends of the same rotational shaft. In some embodiments, a controller may adjust the operation of the dual drive generator system to adjust the system performance in response to sensed parameters in the load electrically coupled to one of the generators. In some embodiments, the dual drive generator system may operate the two generators independently of each other to provide different amounts of real or reactive power to one or more loads, electrical grids, and/or power islands.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A gas turbine, comprising:
a rotational shaft configured to couple to a first generator and a second generator; and
a controller configured to:
receive one or more load parameters that correspond to a first set of electrical properties associated with one or more loads coupled to the first generator, the second generator, or both;
receive one or more sensed parameters from one or more sensors configured to measure a second set of electrical properties associated with the one or more loads;
determine one or more differences between the one or more load parameters and the one or more sensed parameters; and
control one or more operations of the first generator, the second generator, or both based on the one or more differences.

2. The gas turbine of claim 1, comprising:
a first starter controller configured to receive a first set of commands from the controller based on the one or more differences, wherein the first starter controller is configured to control a first set of operations of the first generator; and
a first exciter controller configured to receive a second set of commands from the controller based on the one or more differences, wherein the first exciter controller is configured to control a second set of operations of the first generator.

3. The gas turbine of claim 2, comprising:
a second starter controller configured to receive a third set of commands from the controller based on the one or more differences, wherein the second starter controller is configured to control a third set of operations of the second generator; and
a second exciter controller configured to receive a fourth set of commands from the controller based on the one or more differences, wherein the second exciter controller is configured to control a fourth set of operations of the second generator.

4. The gas turbine of claim 1, wherein the one or more load parameters comprise one or more voltage values, one or more current values, one or more power values, one or more power factor values associated with the one or more loads.

5. The gas turbine of claim 1, wherein the one or more sensors are disposed at one or more locations within the one or more loads.

6. The gas turbine of claim 1, wherein the controller is configured to control the one or more operations by adjusting a rotation of the rotational shaft.

7. The gas turbine of claim 1, wherein the controller is configured to:
determine whether the one or more differences are within one or more threshold ranges; and
control the one or more operations based on whether the one or more differences are within the one or more threshold ranges.

8. A gas turbine system, comprising:
a rotational shaft comprising a first side and a second side;
a first generator configured to couple to the first side of the rotational shaft;
a second generator configured to couple to the second side of the rotational shaft; and
a controller configured to control one or more operations associated with the first generator, the second generator, or both.

9. The gas turbine system of claim 8, wherein the controller is configured to cause the first generator to output real power and the second generator to output reactive power.

10. The gas turbine system of claim 8, wherein the controller is configured to cause the first generator and the second generator to output real power.

11. The gas turbine system of claim 8, comprising an electrical grid configured to couple to the first generator, the second generator, or both.

12. The gas turbine system of claim 8, wherein the first generator is configured to couple to a first load and the second generator is configured to couple to a second load that is different from the first load.

13. The gas turbine system of claim 12, wherein the first generator is configured to output reactive power to the first load and the second generator is configured to output real power to the second load.

14. The gas turbine system of claim 8, wherein the first generator is configured to couple to an electrical grid and the second generator is configured to couple to a load.

15. A method, comprising:
receiving, via a processor, one or more load parameters that correspond to a first set of electrical properties associated with one or more loads coupled to a first generator, a second generator, or both, wherein the first generator and the second generator are configured to couple to a shaft of a turbine;
receiving, via the processor, one or more sensed parameters from one or more sensors configured to measure a second set of electrical properties associated with the one or more loads configured to couple to the first generator, the second generator, or both;
determining, via the processor, one or more differences between the one or more load parameters and the one or more sensed parameters; and
controlling, via the processor, one or more operations of the first generator, the second generator, the turbine, or any combination thereof based on the one or more differences.

16. The method of claim 15, wherein the first set of electrical properties comprises one or more voltage values, one or more current values, one or more power values, one or more power factor values, or any combination thereof.

17. The method of claim 15, wherein the second set of electrical properties is associated with one or more operation characteristics of the one or more loads coupled to the first generator and the second generator.

18. The method of claim 15, wherein controlling the one or more operations comprises determining an adjustment based on the one or more differences in response to the one or more differences being outside a threshold, wherein the adjustment is configured to cause the one or more differences to decrease.

19. The method of claim 18, wherein controlling the one or more operations of comprises sending a command indicative of the adjustment to one or more controllers configured to control the operations of the first generator, the second generator, the turbine, or any combination thereof

20. The method of claim 15, wherein the one or more operations comprise causing the first generator or the second generator to change a frequency value, a voltage value, a power value, a current value, a power factor value, or any combination thereof, associated with an output from the first generator or the second generator.
